(19) United States
(12) Patent Application Publication
(10) Pub. No.: US 2007/0205359 A1
(43) Pub. Date: Sep. 6, 2007

(54) Electronic gas pump

(76) Inventor: Ulrich Bonne, Hopkins, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/365,415

(22) Filed: Mar. 1, 2006

(51) Int. Cl. H01J 49/00

(52) U.S. Cl. 250/287

(57) ABSTRACT

A method and apparatus are provided for pumping gas. The method includes the steps of providing an orifice with an entry diameter that is substantially larger than an exit diameter, imposing a non-uniform electric field between the entry and exit of the orifice and pumping permanent and field induced molecular dipoles through the orifice using the non-uniform electric field wherein the dipoles drift towards a direction of higher field strength within the non-uniform, time-dependent and multi-phase electric field.

### FIELD OF THE INVENTION

The field of the invention relates to microanalytics and more particularly to gas pumps.

### BACKGROUND OF THE INVENTION

Presently available gas pumps for microanalytics are relatively large and use mechanical actuators that are subject to wear and limited service life. The use of mechanical actuators creates undesirable flow pulsations that can only be reduced through bulky buffer volumes. The difficulty of fabricating and assembling such mechanical pumps is significant and contributes to their high price.

Ion drag pumps overcome many of the deficiencies of mechanical pumps. Ion drag pumps first ionize a gas and then use an electric field to attract the ions. As ions are pulled along by the electric field, they also drag along other gas molecules.

However, ion drag pumps require high ionization fields and generate relatively few ions. The high ionization fields consume a relatively large amount of energy for the number of ions produced.

In addition, the relatively few ions are relatively inefficient in dragging along other molecules because their low number causes them to interact with relatively few other molecules. In addition, the ions generate friction as they are pulled though other neutral gas molecules thereby further wasting energy.

While ion drag pumps are an improvement over mechanical pumps, they are still relatively inefficient. Accordingly, a need exists for improved pumping methods for microanalytics.

### SUMMARY

A method and apparatus are provided for pumping gas. The method includes the steps of providing an orifice with an entry diameter that is substantially larger than an exit diameter, imposing a non-uniform electric field between the entry and exit of the orifice and pumping permanent and field induced molecular dipoles towards the smaller orifice using the non-uniform electric field wherein the dipoles drift towards a direction of higher field strength within the non-uniform electric field.

### BRIEF DESCRIPTION OF THE DRAWINGS

FIG. 1 depicts an electronic pump in accordance with an illustrated embodiment of the invention;

FIG. 2 depicts the electronic pump of FIG. 1 used in various combinations; and

FIGS. 3a-b depicts the electronic pump of FIG. 2 under an alternate embodiment using an n-phase source;

FIGS. 4a-b depicts the electronic pump of FIG. 2 under another alternate embodiment using three electrodes; and

FIG. 5 depicts the relative potentials of a three-phase source.

### DETAILED DESCRIPTION OF AN ILLUSTRATED EMBODIMENT

FIG. 1(a) depicts a cut-away side view and FIG. 1(b) depicts a bottom view of an electronic gas pump 10 shown generally in accordance with an illustrated embodiment of the invention. The gas pump 10 eliminates the shortcomings of prior pumps by generating a steady gas flow without requiring ionization. Instead, the pump 10 uses a non-uniform drift E field to move permanent and field induced molecular dipoles. Examples of field induced molecular dipoles include N₂ or O₂ which do not have a dipole unless subjected to an E-field. N₂ or O₂ can be contrasted to H₂O which does have and is a permanent dipole.

Under illustrated embodiments of the invention, these dipoles can be made to drift towards the direction of higher field strength, which may be alternating current (AC) or direct current (DC), but preferably DC. By favoring microscale, low voltages and highly non-uniform field geometries, ionization is inhibited and dipole drift is increasingly favored. In addition, by relying upon molecular dipoles, the pump 10 operates on 10⁶ to 10⁸ more molecules than an ion drag pump.

In general, the pump 10 may be fabricated on a relatively thin (e.g., 1-10 μm) substrate 12. A through-aperture 18 having the shape of a frustrum may be created in the substrate 12 that has a taper 26 at an appropriate ratio (e.g., 3-10:1) progressing from a wide end of the aperture to a narrow end. The diameter of the narrow end 20 in one particular preferred embodiment is approximately 10 μm and the diameter of the wide end 22 is 30 μm or larger. In an even more preferred embodiment, the diameter of the narrow end 20 may be approximately 3 μm and the diameter of the wide end 22 is greater than 30 μm.

The substrate 12 may be provided with electrodes 14, 16 on opposing sides of the substrate 12 that surround opposing ends 20, 22 of the aperture 18. A power supply 24 of an appropriate voltage (e.g., 10 volts) is connected to the electrodes 14, 16 with the positive side of the power supply 24 connected to the electrode 14 on the narrow end 20 of the aperture 18. The voltage of the power supply 24 may be chosen to achieve an electric field in the range of from 10⁴-10⁵ V/cm.

In general, the taper 26 of the aperture 18 causes the non-uniform E-field within the aperture 18. The small size of the aperture 18 is contemplated and preferred because the E-field non-uniformity becomes commensurate with the molecular dipole dimensions of 0.2-1.2 nm, thereby reducing the voltage requirements of the power supply 24 and the formation of free electrons (corona discharge) and positive ions.

In general, the electronic pump 10 moves molecules (e.g., dipole 28) via electrostatic forces acting on permanent or E-field induced molecular dipoles. To provide an appreciation of the practicality and feasibility of the pump 10, the forces of electric fields on dipoles 28 may by compared with the forces on ions.

The net force of a non-uniform electric field, E, on the (+) and (−) electric dipole charges, q, can be characterized by the equation F_{dipole}=q(E₂−E₁), where E₁ and E₂ are the electric fields on opposing ends of the molecular dipole 28. In the case of the dipole 28, E₁ is different than E₂ because of the length, L, between the (+) and (−) charge of the dipole, in relation to the field gradient dE/ds, where S is a spatial parameter related to the non-uniform field geometry of the aperture 18. Because the dimension of L<<S=Σs, where S is the spacing between the electrodes 14, 16, the value E₂ may be approximated by the expression E₂=E₁(1−L/S)^{m}, depending on the location in the non-uniform field and where m is some value having the range 1≦m≦2.

In contrast to ions where qᵢₒₙ=qₑ=1.6×10⁻¹⁹, the induced charge of a dipole 28 depends on its molecular polarizability, α. In the case of the dipole 28, the induced charge may be described by the equation, q_{dipole}L=αE′=A·E′/(4πN_{A}/3), where E′ is the electric field at the molecule, which in the gas phase may be assumed equal to E, and A=molar refractivity, which is an atomic property that holds its value relatively well, regardless of the molecular bond of that atom, its gas pressure or gas phase (gas or liquid). For example, the A values for I=2.01, H=1.02, C=2.11, S=8.23, Cl=5.72, air=4.37 and C8H18=39.19 cm³/molecule.

A ratio of forces that compares dipoles with ions can be written as follows.
R=F_{dipole}/Fᵢₒₙ=q_{dipole}·E(L/S)^{m}/qₑ·E=A·E·(L/S)^{m}{L(4π·N_{A}/3)·qₑ
Using values of A=4.37 for air, E=10⁵-10⁵ V/cm, S=10−1 μm, L=3, A=3×10⁻⁸ cm, and N_{A}=6.02×10²³ produces the result as follows,

$$\begin{matrix}R = 4.37 \cdot {10}^{4} \cdot {( 3 \cdot {10}^{- 8} / {10}^{- 3} )}^{m} / \\ \{ 3 \cdot {10}^{- 8} \cdot ( 4 \cdot π \cdot 6.02 \cdot {10}^{23} / 3 \cdot 1.6 \cdot {10}^{- 19} \\ = 108 for a value of m = 1 , or \\ = 0.0032 for m = 2\end{matrix}$$

The value of R assumes larger values in the case where for E=10⁵ V/CM and S=1 μm. For the latter example and where m is assumed to take and even larger value (e.g., m=3), R=0.00097. In any case these results show that the forces on dipoles can be smaller but comparable to those on ions. But this is all that is needed to demonstrate the potential of this approach, especially in view of the fact that this can be done with concentrations of dipoles that are 10⁵-10⁷ times higher than those of ions, because the force is applied to all the molecular dipoles present in the field, rather than to an approximately 10⁻⁷ fractional concentration of ions.

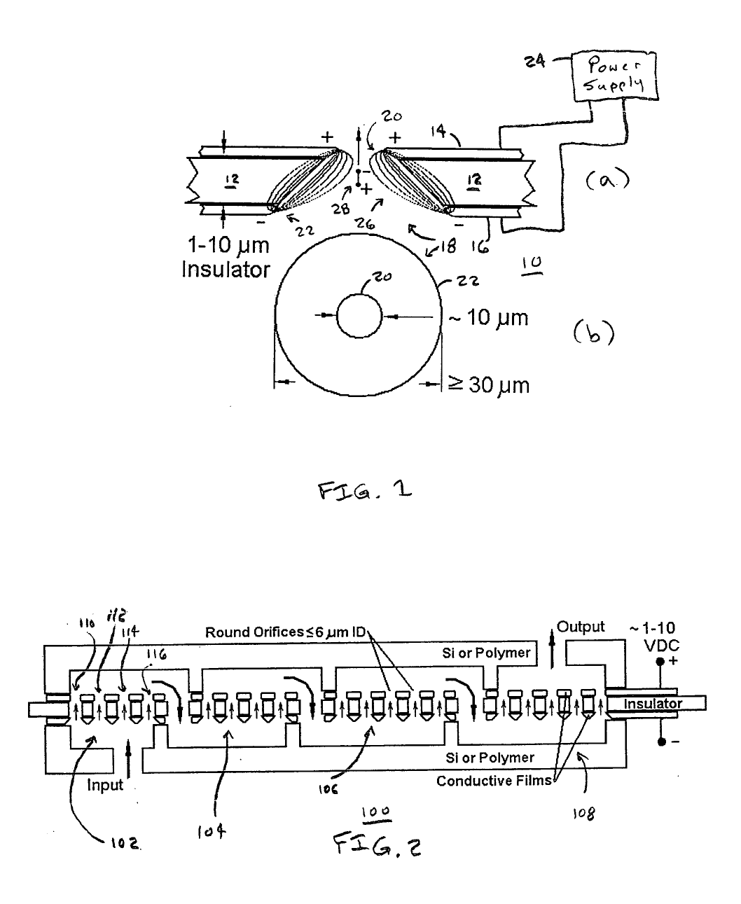

Under other embodiments, the pump 10 of FIG. 1 may be grouped into a parallel and/or a series arrangement to achieve desired flow and pressure objectives. Under a first arrangement (FIG. 2), a grouping of pumps 110, 112, 114, 116 may be arranged in parallel to achieve a predetermined flow rate that is a multiple of that which could be achieved by the pump 10 of FIG. 1. In addition, the parallel grouping 102 of pumps 10 can be replicated and connected in series to form series connected groups 102, 104, 106, 108 that achieves a predetermined pressure that is multiple of any one group 102.

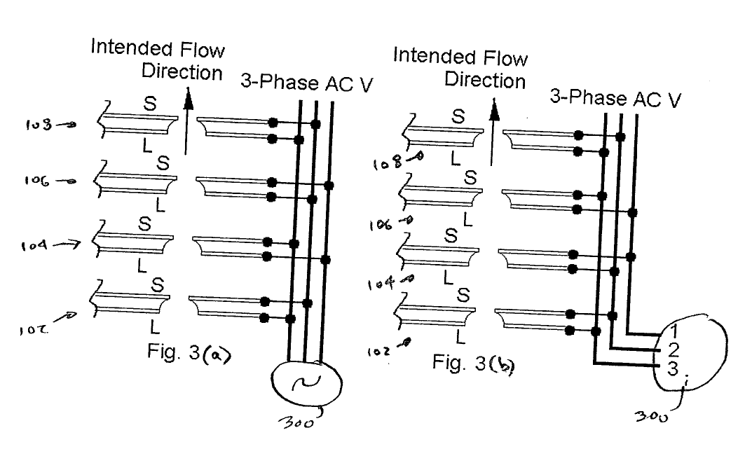

In another alternate embodiment (FIGS. 3a-b, 4a-b), the series connected groups 102, 104, 106, 108 may be connected to an n-phase (e.g., 3-phase) voltage source 300. In this case, the permanent and field induced molecular dipoles drift towards the higher field strength of the narrow end 20, as described above. Each time the field reverses, the molecular dipoles 28 that have not passed through the orifice 18 would also reverse while continuing to drift towards the narrow end 20 of the orifices through the non-uniform drift electric field.

In the case of FIG. 3a, there is no net e-field between the wide end 22 (L) of an orifice 18 of the lower grouping 102 to the narrow end 20 (S) of the next higher grouping 104 because the two electrodes are connected to the same phase of the source 300. For example, beginning with the grouping 102, a dipole 28 will experience a force towards the stronger field near the narrow end S of the group 102. After arriving at the narrow end S of the first group 102, the dipole 28 will not experience a force pulling it towards the next group 104 because while the wide end L of group 104 is connected to a different phase, the narrow end S of group 104 is connected to the same phase of the source 300. However, dipoles 28 that finally approach the wide end 22 of group 104 do experience a force and subsequent movement towards the narrow end 20 of group 104 creates a vacuum that pulls the other dipoles 28 (and neutral molecules) through the space between groups 102, 104, just as the strongly non-uniform force that got those molecules through the first group 102 begins to fade. The net effect is the same as the dipoles 28 pass through each of the groups 102, 104, 106, 108.

In the case of FIG. 3b, there is a force on the dipoles 28 between groups 102, 104, 106, 108 because even though the narrow end S of the first group 102 is connected to the same phase as the wide end L of the next group 104, the narrow end S of the second group 104 is connected to a different phase. The intergroup force is smaller than the force within the orifices 18, but still acts to attract the dipoles 28 across the intervening space between groups 102, 104, 106, 108.

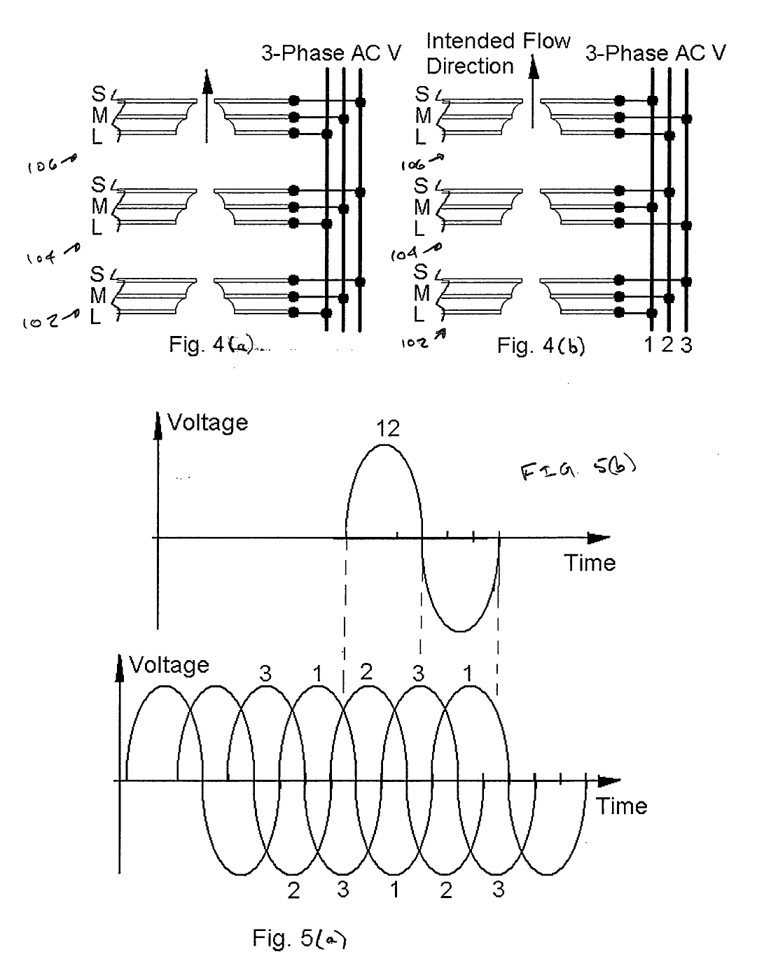

FIG. 4a depicts a sandwich arrangement of two substrates 12 with a dividing electrode M and outside electrodes L, S. The three electrodes S, M, L are connected to different phases.

In this case, dipoles 28 are strongly urged through the orifice 18 by a non-uniform electric field created by electrodes S, M, L. However, there is no force on the dipoles 28 between groups 102, 104, 106 because the corresponding electrodes S, M, L in each group are connected to the same phase. As a result the multistage pump of FIG. 4a, again, relies upon a vacuum to pull dipoles (and neutral molecules) between groups 102, 104, 106

In FIG. 4b, electrodes S, M, L are each connected to different phases of the source 300. In the case of FIG. 4b, a small force exists between groups 102, 104, 106 as was the case in FIG. 3b in addition to the large force within the orifices 18.

Overall, the multistage and multiphase pumps of FIGS. 3a-b and 4a-b overcome the stagnation that would occur with a dc potential or only a single phase, even if many stages were connected in parallel. The pumping arrangement of FIGS. 3b and 4b generate a pull between groups 102, 104, 106 in addition to the pull within the orifice 18, while the other pumps of FIGS. 3a and 4a experience a pull and push due to the created micro-volumes of vacuum and compression.

It should be noted that the dipole attraction is insensitive to polarity, thus generating attraction towards the stronger (−) or (+) electrodes (i.e., orifices 18). Since dipoles 28 can be attracted to (+) or (−) non-uniform fields, the AC frequency of the source 300 can be adjusted to match the drift velocity and spacings between groups 102, 104, 106, 108.

FIG. 5a-b shows how the 3-phase voltages relate to ground or neutral (ground) and, more importantly, how they relate to each other. The top sketch (FIG. 5a) shows the potential for leads 1 and 2, which may be related to leads 1 and 3 or leads 2 and 3 by another set of sine waves, except for a 120 degree shift.

In still further alternate embodiments, the pump 10 may be used as a valve. In this case, the voltage applied to the electrodes 14, 16 is chosen to oppose and balance an external pressure (e.g., to facilitate valve-less injection of a preconcentrated analyte from a sample gas #1 such as air into a carrier gas stream #2, such as hydrogen.

In still another embodiment, the pump 10 may be used as a selective pump. In this case, the pump 10 may be used to preconcentrate polar gas molecules (e.g., those with strong dipoles).

The pump 10 offers a number of advantages over prior devices. For example, the pump 10 saves energy over ion-drag pumps because the large unrecoverable energy required to generate ions is eliminated. The pump is more efficient than AC pumps because of the elimination of ohmic conductor and dielectric material losses.

Further, the pump 10 is non-destructive. For example, analytes are not fragmented as are molecules in ion-drag pumps, which enables the positioning of one or more pumps 10 along a separation column.

The pump 10 eliminates flow pulsations and the need for buffer volumes. Since the pump 10 relies upon an electric field for pumping, there is no mechanical noise and no mechanical wear.

A specific embodiment of an electronic pump has been described for the purpose of illustrating the manner in which one possible alternative of the invention is made and used. It should be understood that the implementation of other variations and modifications of embodiments of the invention and its various aspects will be apparent to one skilled in the art, and that the various alternative embodiments of the invention are not limited by the specific embodiments described. Therefore, it is contemplated to cover all possible alternative embodiments of the invention and any and all modifications, variations, or equivalents that fall within the true spirit and scope of the basic underlying principles disclosed and claimed herein.

1. A method of pumping gas comprising:
providing an orifice with an entry diameter that is substantially larger than an exit diameter;
imposing a non-uniform electric field between the entry and exit of the orifice; and
pumping permanent and field induced molecular dipoles through the orifice using the non-uniform drift electric field wherein the dipoles drift towards a direction of higher field strength within the non-uniform electric field.

2. The method of pumping gas as in claim 1 further comprising disposing the orifice within an electrically insulating substrate.

3. The method of pumping gas as in claim 2 wherein the substrate further comprises a thickness between 1 and 10 μm.

4. The method of pumping gas as in claim 1 further comprising disposing electrodes on opposing sides of the substrate around the orifice.

5. The method of pumping gas as in claim 1 further comprising imposing an electric field of between 10⁴ and 10⁵ volts per cm across the electrodes on opposing sides of the substrate.

6. The method of pumping gas as in claim 1 further comprising a ratio between exit and entry diameters wherein the entry diameter is between 3 and 10 larger than the exit diameter.

7. The method of pumping gas as in claim 6 wherein the exit diameter further comprises approximately 10 μm.

8. The method of pumping gas as in claim 1 further comprising providing a plurality of the orifices, in parallel, each with the non-uniform electric field between an entry and exit of the plurality of orifices to achieve a greater pumping volume.

9. The method of pumping gas as in claim 1 further comprising providing a plurality of the orifices, in series to achieve a greater pumping pressure.

10. The method of pumping gas as in claim 9, comprising the application of n-phase voltage to n subsequent layers in series by stacking insulator and conductor layers, with respective orifices of substantially equal taper.

11. The method of pumping gas as in claim 1 further comprising providing a first plurality of the orifices in series to achieve the desired pressure head and a second plurality of the orifices in parallel to achieve the desired volumetric flow.

12. An apparatus for pumping gas comprising:
an orifice with an entry diameter that is substantially larger than an exit diameter;
a non-uniform electric field between the entry and exit of the orifice; and
permanent and field induced molecular dipoles that are pumped through the orifice using the non-uniform drift electric field wherein the dipoles drift towards a direction of higher field strength within the non-uniform electric field.

13. The apparatus for pumping gas as in claim 12 further comprising an electrically insulating substrate.

14. The apparatus for pumping gas as in claim 13 wherein the substrate further comprises a thickness between 1 and 10 μm.

15. The apparatus for pumping gas as in claim 12 further comprising electrodes on opposing sides of the substrate around the orifice.

16. The apparatus for pumping gas as in claim 12 further comprising an electric field of between 10⁴ and 10⁵ volts per cm disposed across the electrodes on opposing sides of the substrate.

17. The apparatus for pumping gas as in claim 12 further comprising a ratio between exit and entry diameters wherein the entry diameter is between 3 and 10 times larger than the exit diameter.

18. The apparatus for pumping gas as in claim 17 wherein the exit diameter further comprises approximately 10 μm.

19. The apparatus for pumping gas as in claim 12 further comprising providing a plurality of the orifices, in parallel, each with the non-uniform electric field between the entry and exit of the orifices to achieve a greater pumping volume.

20. The apparatus for pumping gas as in claim 12 further comprising providing a plurality of the orifices, in series to achieve a greater pumping pressure.

21. The apparatus for pumping gas as in claim 20, comprising the application of n-phase voltage to n subsequent layers in series, by stacking insulator and conductor layers, with respective orifices of substantially equal taper.

22. The apparatus for pumping gas as in claim 12 further comprising providing a first plurality of the orifices in series to achieve the desired pressure head and a second plurality of the orifices in parallel to achieve the desired volumetric flow.
